(19) United States
(12) Patent Application Publication
(10) Pub. No.: US 2003/0016856 A1
(43) Pub. Date: Jan. 23, 2003

(54) Method and apparatus for image processing and display

(76) Inventors: James K. Walker, Gainesville, FL (US); Stephan A. Tuchman, Gainesville, FL (US); William E. Loeffler, Gainesville, FL (US); Kelvin D. Walker, New York, NY (US); Fredric F. Derwitsch, Melbourne, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/188,015

(22) Filed: Jul. 1, 2002

Related U.S. Application Data
(60) Provisional application No. 60/302,012, filed on Jun. 29, 2001.

(51) Int. Cl. G06K 9/00

(52) U.S. Cl. 382/132

(57) ABSTRACT

An apparatus and method for acquiring and processing digital images obtained and displayed through an electrically operated device. Image data may be processed in real time to include features of magnification, contrast brightness, image inversion, edge enhancement, quantitative measurement, image equalization, computer assisted diagnosis, voice recognition, and a high resolution display. The apparatus includes a power zoom lens, imaging chip, digital signal processing, LCD display, and rechargeable battery pack.

### CROSS-REFERENCE TO RELATED APPLICATION

The present application claims the benefit of U.S. Provisional Application No. 60/302,012, filed Jun. 29, 2001, which is hereby incorporated by reference herein in its entirety, including any figures, tables, or drawings.

### BACKGROUND OF THE INVENTION

Detailed image analysis is important in many fields of medicine, industry and science, including but not limited to radiology, dermatology, pathology, and forms of medical endoscopy. Within endoscopy applicable sub-categories can include: laparoscopy, thoracoscopy, arthroscopy, gastroscopy, hysteroscopy, colonoscopy, bronchoscopy and dental application of endoscopy. Devices used for traditional non-sophisticated patient exams such as the otoscope (for examination of the ear), ophthalomoscope (examination of the eye), larynx illuminator (throat), nasopharynx illuminator (nasal passages), and anoscope (lower GI tract) typically rely on the human eye and simple magnification systems. The non-destructive inspection of equipment and materials, commercial, industrial and military applications utilizing endoscopic inspection instruments such as borescopes can be applicable to metallurgy, microelectronics, forensic evidence collection and evaluation, education, art, biology, botany, chemistry, geography, and history.

For example, early detection of tissue malignancy is essential to avoid the spread of cancer and associated complications. Breast cancer is a leading cause of death among women aged 20-59 in the US, and the leading cause of cancer death for women worldwide. In 2001, it is estimated 233,000 new cases of breast cancer will be diagnosed and about 40,000 women will die from the disease. Early detection of breast cancer can greatly affect the outcome in many situations. Mammography is acknowledged to the single most effective method of screening for breast cancer. In randomized clinical trials, screening mammography reduces the rate of mortality from breast cancer by about 30% for women aged 50 to 70. Accordingly, approximately 60 million mammograms are performed annually in the US and Europe.

More than 99% of these procedures are performed with the screen/film technique. There is wide agreement that screen/film will likely be the dominant modality in mammography for many years. The radiographer typically spends less than one minute reviewing a patient's films. When there is a suspected pathology on the film image, a magnifying glass lens is frequently used to help make the decision whether to perform an additional diagnostic work-up. For a variety of reasons, about 25% of cancer is missed, and only about 5% of patients receiving a diagnostic work-up actually have cancer. Thus, there is a continuing need for improving the sensitivity and specificity of screen/film mammography.

There is clearly room for improvement in the screening and diagnosis of breast cancer partly because of technical limitations of the current method. It is technically difficult to consistently produce mammograms of high quality. Interpretation of the mammograms can be somewhat subjective and can vary among radiologists. Roughly 10% of all screening mammograms require further diagnostic work-up due to the detection of some perceived possible abnormality. The diagnostic work-up may include other mammographic views, magnified views, and/or ultrasound studies. As a result of these studies, approximately 25% of the diagnostic cases are sent for a biopsy. As much as 80% of all biopsied breast lesions turn out to be benign. This situation is illustrated in FIG. 1.

It should be noted in FIG. 1 that there are three decision-making points, indicated by 1, 2, and 3. The radiologist at each of these points balances the need for high sensitivity for detecting abnormalities (leading to high cancer detection) with the need to keep the number of unnecessary additional interventions to a low level (keeps costs low). The average cost to the health system at each of these decision points is shown in Table 1. Accordingly, it is desirable to increase the sensitivity for detection of abnormality at each of the decision points, 1, 2, and 3. Any improvement in detection sensitivity will reduce the current 25% of missed breast cancer.

Since about 75 to 80% of the total $5.0 billion of the diagnostic work-up and biopsy cases result in diagnoses of benign abnormalities, even a small improvement in specificity would result in savings of many millions of dollars. Currently, radiologists often use a magnifying glass lens to get a better look at any suspected pathology on the film image during review of the mammogram and the diagnostic work-up.

TABLE 1
Costs involved at the Decision Points in the Diagnostic Work-up.

| Decision | | Average | No. of | | | |
|---|---|---|---|---|---|---|
| Point | Stage | Cost | Patients | | Total Cost | |
| 1 | Mammography | $100 | 60 | M | $6 | Billion |
| 2 | Diagnostic | $500 | 6.0 | M | $3 | Billion |
| | Work-up | | | | | |
| 3 | Biopsy | $2,000 | 1.25 | M | $2.5 | Billion |

Cancer of the skin is the most common of all cancers. Melanoma accounts for about 4% of skin cancer cases, but causes about 79% of skin deaths. Visual interpretation of skin lesions is the prevalent method of diagnosing skin disorders. Despite many years of physician training, their diagnoses are subjective and prone to the limitations of human vision. To ensure high sensitivity for cancer detection, physicians typically order so many biopsies of “suspicious” lesions that only 2-3% of the biopsies turn out to be melanoma. Therefore, an apparatus and method for providing improved visual exams with image enhancements could improve visual observation and reduce the number of unnecessary biopsies.

Despite centuries of development, most surgery today is, in at least one respect, much the same as it was many years ago. Traditionally, the problem has been that surgeons must often cut through many layers of healthy tissue in order to reach the structure of interest, thereby inflicting significant damage to the healthy tissue. The surgeons must then seek out troubled areas with limited visual assistance. Recent technological developments have dramatically reduced the amount of unnecessary damage to the patient, through the use of various endoscopy devices. These endoscopy devices enable the physician to visualize aspects of the patient's anatomy and physiology without substantially disrupting the intervening tissues. Many limitations to existing endoscope technology result in the surgeon's view being limited to identifying larger visible areas that appear directly in front of the scope. The camera must frequently be readjusted to seek out exact locations of abnormalities extending the time of procedures. The ability to visualize large pathology is often not a problem, while identifying small subtle lesions or flat low contrast lesions can be difficult. Unfortunately, by the time lesions and other pathology are large enough to be obvious they may be in an advanced stage such that it may be too late to provide successful intervention. The ability to identify abnormalities at the earliest stages is of paramount importance.

For example, with respect to lung cancer, there are some forms of the disease which are very difficult to detect by conventional X-ray or even by computed tomography. In these cases, the diseased tissue remains largely in the plane of the normal tissue of the bronchi rather than developing into the air space of the bronchi. In this case, inspection of the walls of the bronchi can be made with a bronchoscope. The difference in reflectivity, color, or surface structure of the diseased region of the bronchi may be subtle and may not be detected by conventional inspection. In another example, similar remarks can be made concerning cancer of the colon where some forms of the disease do not proceed through the stage of easily seen polyps. Instead, the disease does not invade the interior of the lumen of the colon. The detection of the disease by a conventional colonoscope exam is therefore problematic. In both of these examples, therefore, there is a need for an apparatus and method for providing an enhancement tool to existing scopes in order to provide enhanced images that may result in earlier diagnosis.

Visual inspection continues to be the leading non-destructive evaluation (NDE) method for inspection procedures that are applied to aircraft in service. To enhance the inspection capability, new tools have been developed, including improved illumination techniques, miniature video and dexterous small-diameter borescopes. In recent years, two visual inspection techniques have emerged, D-Sight and Edge of Light (EOL). Industries use non-destructive inspection systems to inspect areas that may have areas that are inaccessible and require searching for objects that may have defects. These systems generally utilize some form of cameras and in some cases radiography devices such as X-rays are utilized to detect internal defects along with ultrasonics, thermography and shearography. The visual inspection of products and equipment for safety and quality control reasons provides a major area of concern since the human eye and devices such as the magnifying glass or magnifying lens coupled to a digital camera have limitations in their usefulness. It is usually the very small non-obvious areas that go undetected such that more serious and dangerous results many times occur. In some cases a distortion will result in a false positive, resulting in satisfactory items being rejected and, thus, additional expenses. Even the more sophisticated inspection devices such as borescopes typically do not provide real-time image enhancement features other than magnification.

Visual inspection is probably the most widely used of all the nondestructive tests used for aircraft maintenance. It is simple, quickly carried out, and usually low in cost. The basic principle used in visual inspection is to illuminate the test specimen with light and examine the specimen with the eye. In many instances, aids are used to assist in the examination. The method is mainly used to assist in the inspection of defects and to permit visual checks of areas not accessible to the unaided eye.

Visual and optical tests are often carried out in aircraft maintenance with the following equipment:

1. Magnifying glass—generally consist of a single lens for lower power magnification and double or multiple lenses for higher magnification;

2. Magnifying mirror—a concave reflective surface, such as a dental mirror used to view restricted areas of the aircraft not accessible with a magnifying glass;

3. Microscope—a high power magnifier used for the inspection of parts removed from the aircraft;

4. Flexible fiber borescope—a precision optical instrument with built-in high intensity illumination, some having magnification and zoom controls;

5. Flexible fiber optic borescope—permits manipulation of the instrument around corners and through passages with several directional changes, working at lengths 60-365 cm; and

6. Video imagescope—similar to a fiber optic borescope with the exception that it has a video camera and TV monitor in place of an eyepiece. The field of vision is up to 90% and the probe can have four-way articulation.

Presently, forensic evidence collection relies predominantly on visual inspection and standard digital and film cameras. Due to the limitations of these techniques, evidence often remains undiscovered. The suspected area may be exposed to powders and chemicals to enhance the identification of a substance of interest and thus provide some assistance in certain cases. However, it is difficult to cover large areas and once evidence is located the time delay of image enhancement or analysis in the laboratory may be required. There is therefore a need for a portable real time image enhancement camera and display system which will reveal subtle evidence rapidly on the scene.

Approximately 1.8 billion conventional X-ray exams are performed annually worldwide. More than 99% of these procedures are recorded on film and read on light boxes for diagnostic interpretation. In total, more than 2 million diagnosticians perform X-ray interpretations. X-rays, such as chest radiographs reviewed by physicians, frequently require the added use of a magnifying glass or an illuminator to provide better visualization of the image. In many cases, the interpretation of X-rays requires the use of a high intensity illuminator, sometimes referred to as a hot light, to assist the physician in visualizing dark areas of the film. The ability to increase the clinical information content of an X-ray with no increase in radiation dose can diminish diagnostic uncertainty and reduce the amount of unnecessary and costly diagnostic procedures.

### BRIEF SUMMARY OF THE INVENTION

The present invention, relates to an apparatus and method for acquiring and/or processing images in real-time. In a specific embodiment, the subject invention pertains to a hand-held camera with built-in, real-time image processing and enhancement capabilities and a LCD or other flat panel display or monitor. The system can receive images from a variety of sources and provides the user with options for processing the image through an ergonomically designed control and displayed on an attached LCD display. Situations which may benefit from the subject method and apparatus include, but are not limited to, detecting calcifications in mammography, detecting lesions in the lung which may not be apparent in standard chest exams, detecting subtle hairline bone fractures, detecting cracks in jet engine rotary blades, detecting cargo hold rust in offshore oil tankers, detecting cracks in gas or oil pipelines, inspecting buildings and homes, inspecting gun barrels and machine borings, inspecting diesel fuel injections, inspecting hydraulics, inspecting diesel and gas engine cylinders, inspecting furnaces, and inspecting nuclear reactors.

In a preferred embodiment, the subject device relates to a hand-held instrument similar in size to a traditional magnifying glass lens, which incorporates zoom magnification from about 1 to about 6, resolution of up to 20 lp/mm, window leveling, edge enhancement, and image inversion. In essence, this hand-held magnifier can have many of the attractive features of a mammography workstation. Yet unlike digitized film images, or digitally acquired images, an image produced by the subject device can retain the high spatial resolution of the original film image.

### BRIEF DESCRIPTION OF THE DRAWINGS

FIG. 1 shows a decision flowchart typically used for the detection of breast cancer.

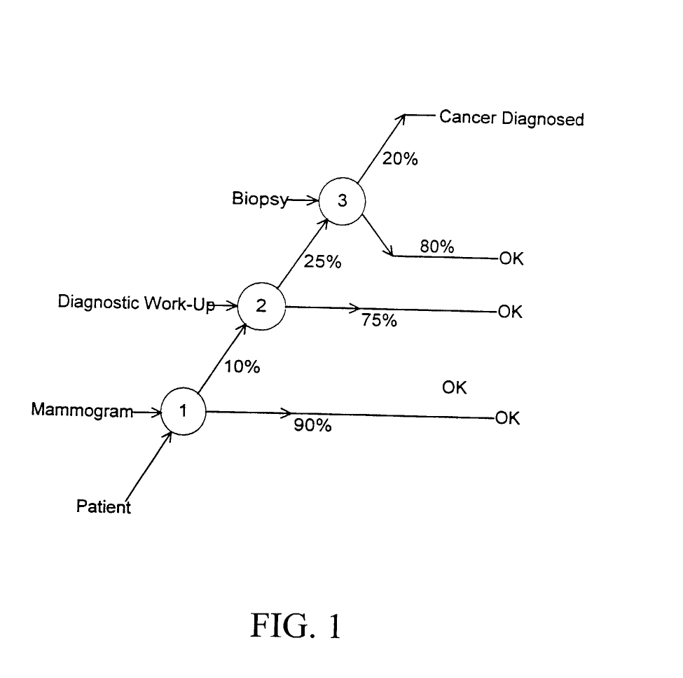

FIG. 2 shows a schematic of a specific embodiment of the subject invention pertaining to a hand-held portable smart cam and cradle.

FIG. 3 shows a side view of the embodiment of the subject invention shown in FIG. 2, incorporating a camera and an LCD screen.

FIG. 4 shows a front view of a specific embodiment of the subject invention showing a tool bar with various image processing features on an LCD screen.

FIG. 5 shows the use of a specific embodiment of the subject invention for viewing an X-ray film.

FIGS. 6A-6F schematically illustrates several of the image-enhancing processes which can be incorporated with the subject invention.

FIG. 7 shows a specific embodiment of the subject invention having a processor located behind the LCD screen, which can be used to image X-ray films.

FIG. 8 shows a specific embodiment of the subject invention being used to image a mammographic film attached to a holding device.

FIG. 9 shows another specific embodiment of the subject invention which processes and displays images received from an endoscope.

FIG. 10 shows the invention as a mobile device mounted on wheels to be moved over an area of inspection.

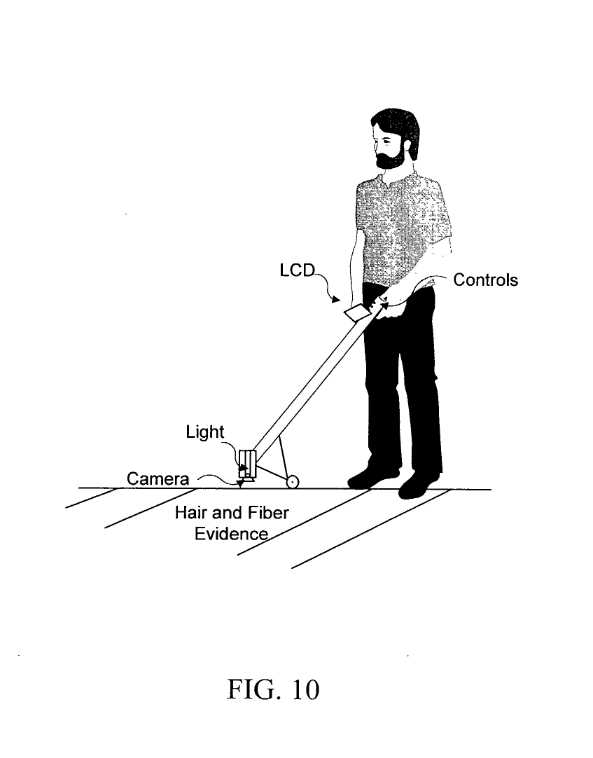

### DETAILED DISCLOSURE OF THE INVENTION

The present invention relates to an apparatus and method for providing high resolution enhanced images in a real time mode. In a specific embodiment, the subject apparatus can incorporate a mobile hand-held camera and built-in real-time processing enhancement capabilities with the resulting enhanced images displayed on an LCD display. The subject method of real-time image processing may also be adapted for use with a variety of cameras and viewing devices. Image enhancements which may be accomplished by the subject invention in real time include, but are not limited to, magnification, manipulation of image, windowing intensification, high resolution, high contrast, image inversion, image intensity enhancement, and edge enhancement.

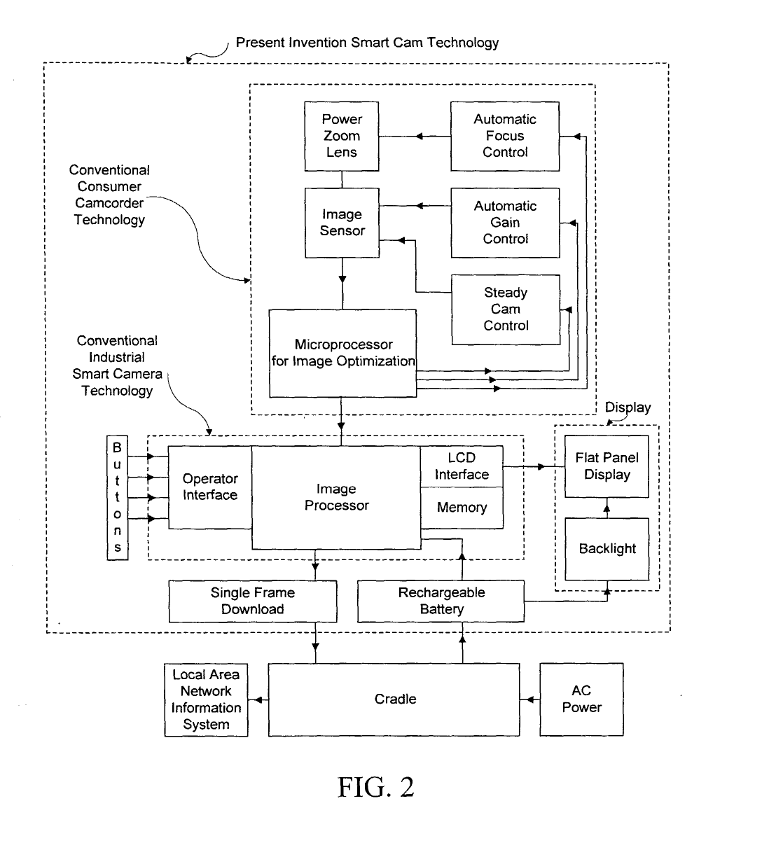

The subject camera can incorporate a frame grabber with hardware or firmware that performs image processing algorithmic primitives at real-time rates. The processing can be done by embedded microprocessors, field-programmable gate arrays (FPGAs), digital signal processors (DSPs), array processors, application specific integrated circuits (ASICs), and other hardware. A schematic of the components of a specific embodiment of the present invention is shown in FIG. 2. The embedded processor, memory, serial interface, and digital interface to the flat panel display are shown in the figure. The user, through button controls, can implement the desired image enhancement algorithms. The results may then be seen in real-time on the flat panel display.

The subject smart cam can incorporate, for example, technologies based on conventional consumer camcorders and/or conventional industrial smart camera technology. A dashed line surrounds the region of FIG. 2 which corresponds to conventional consumer camcorder technology. A second dashed line surrounds the region which corresponds to conventional industrial smart camera technology. Conventional industrial smart camera technology is often employed in robotic function and monitoring in industrial processes. A third dashed line surrounds the flat panel display (FPD) which may be, for example, a liquid crystal display (LCD). Consumer camcorder technology normally would include an interface and FPD. In the present invention, which unites the technologies of the consumer camcorder and the industrial smart camera technology, the FPD can be interfaced to the industrial smart camera technology. This permits the display of processed and enhanced images to the operator. This symbiotic union of existing well-known technologies is referred to herein as the smart cam.

There are some novel advantages which accrue from the smart cam technology of the present invention. These include:

1. Because of the use of automatic focus control, the desired very high spatial resolution of the image can be maintained in real time and optimally processed for image enhancement even when the camera object distance is being changed by the user.

2. Because of the use of automatic gain control in the first stage consumer camera technology section of the smart cam, the required number of bits which characterize the pixel intensity can be reduced in the second stage industrial smart camera technology. This reduced demand on that technology may permit lower cost, faster processing, or both.

3. The use of the steady cam consumer technology can allow optimal processing for image enhancement even when the camera is subject to “shake” by the user.

4. The smart cam technology can provide the user the potential to view objects which are so faint or low in contrast that they would not otherwise be able to be easily seen with hand-held operation.

5. The smart cam technology can provide the user the potential to clearly delineate the edges of very low contrast objects in an image even with hand-held operation.

6. Whereas the industrial smart camera, which is normally fixed in space, can provide information which is used to automatically control a process; in the present invention, the smart cam can provide the human user real-time information, such as items 4 and 5 above, which allows the user to make informed, real-time decisions and change the course of events.

Conventional consumer camcorder technology can include a steady cam feature for reducing the impact of hand shake, automatic exposure control, and auto focus for providing a sharp image continuously. Although FIG. 2 shows an embodiment incorporating both conventional consumer camcorder technology and conventional industrial smart camera technology, alternative embodiments of the subject invention can incorporate either conventional consumer camcorder technology or conventional industrial smart camera technology, and optionally a portion of the other. For example, there are two primary methods of endoscopy, fixed lens endoscopy utilizing a fixed lens and an image guide to transport an image to a camera where the image can then be displayed, and video endoscopy utilizing a video camera mounted at the distal end of the endoscope where the image is conveyed through cables for display. Fixed lens endoscopy, in accordance with the subject invention, can incorporate, for example, steady cam and/or automatic exposure control. Video endoscopy in accordance with the subject invention can incorporate steady cam, automatic exposure control, and/or auto focus. The image which is produced by the endoscope with one, two, three, or none of these features can then be processed by conventional industrial smart camera technology including, for example, one or more of the following: edge enhancement, intensity windowing, and image inversion. The processing of endoscopic images in accordance with the subject invention can provide real-time enhancement of the images, which can enhance the resulting diagnostic outcomes.

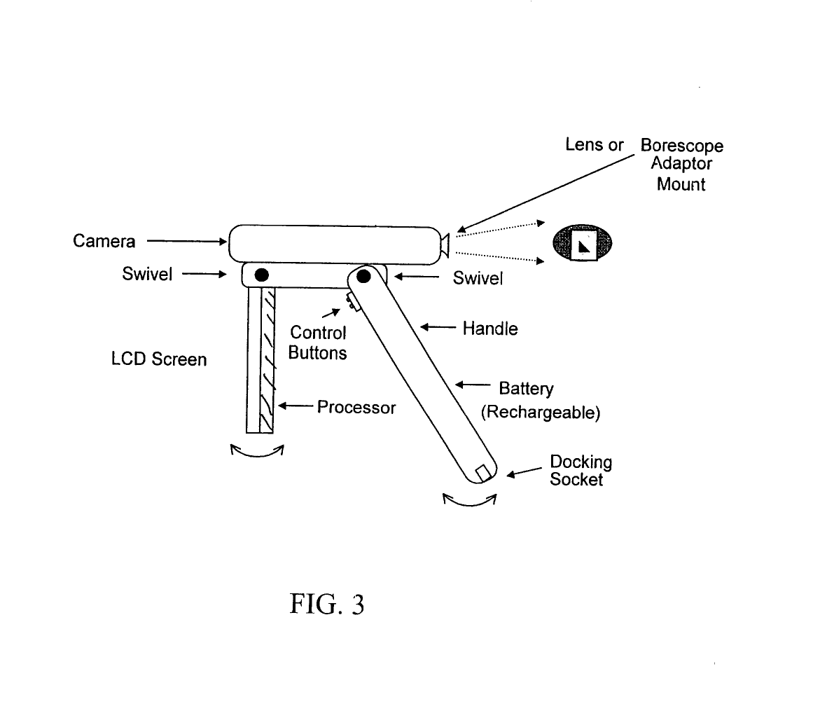

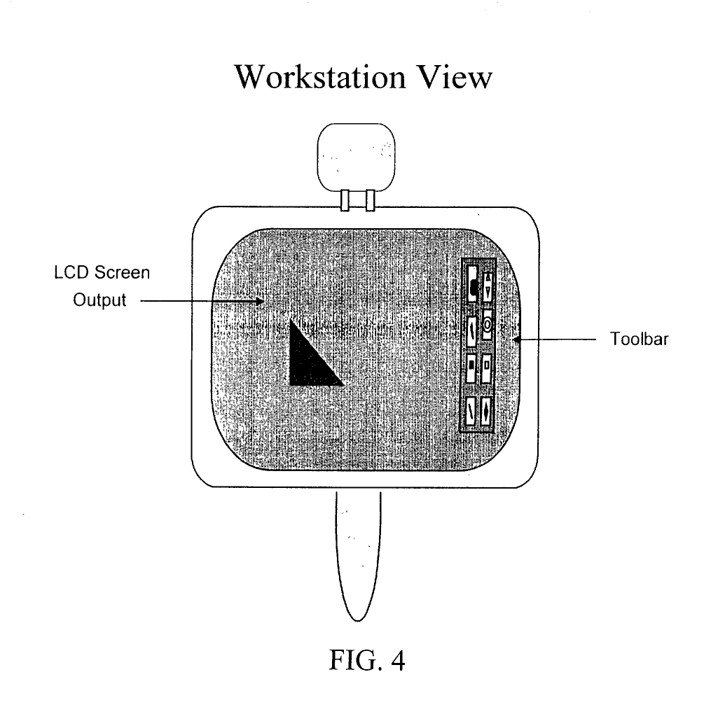

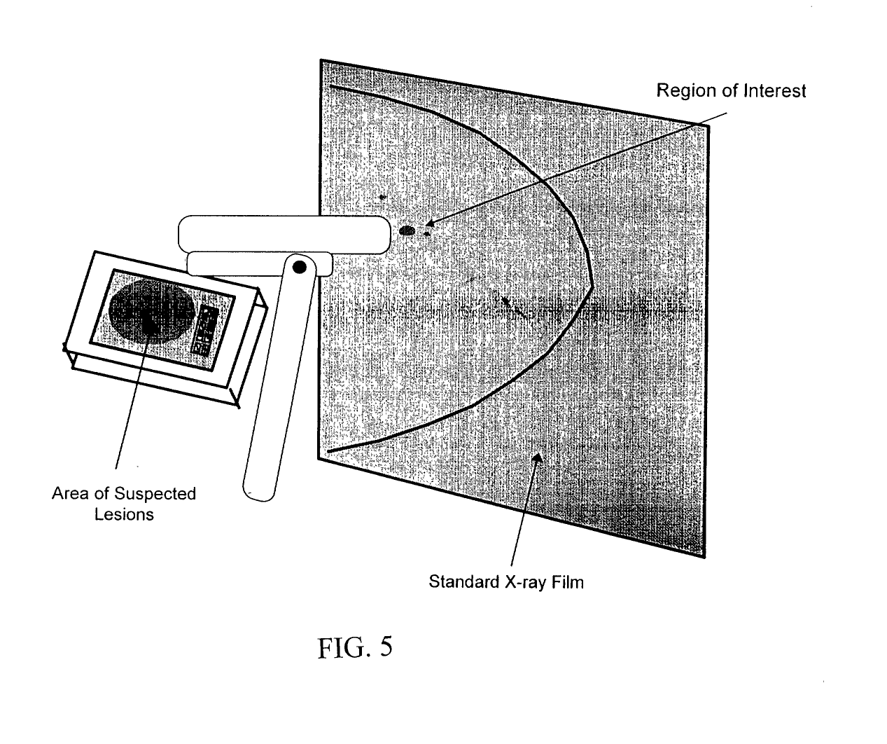

In a specific embodiment, the present invention can utilize an image capture device that includes a camera utilizing a CMOS or CCD megapixel camera chip, a power zoom lens with automatic focus and steady cam operation, a digital signal processor (DSP) which operates at 600 MHZ. Image enhancement of the 30 frames per second video images can include one or more of the following: intensity windowing, edge enhancement/sharpening image inversion, and image inversion. Measurement functions can be included if desired. Voice recognition can provide the user with the option of giving voice-activated controls. A diagonal LCD display with a SXGA (1280×1024 pixels) resolution on a 6.3 inch diagonal size screen can allow a user to view the resulting images. In a specific embodiment incorporating a camera utilizing a CMOS or CCD megapixel camera chip, a power zoom lens with automatic focus and steady cam operation, a 600 MHZ DSP, a diagonal LCD display with a SXGA (1280×1024 pixels) resolution on a 6.3 inch diagonal size screen, and a rechargeable battery, the entire system can weigh less than about 22 oz. (see FIGS. 3, 4, and 5).

The present invention can provide computer assisted diagnosis software features which can aid the user in identifying and marking regions of interest that have been identified. In a preferred embodiment, the ability to send information, including single frame images, to another source electronically via an electronic link, which may be wire, fiber optic, or wireless, can be included with a further enhancement to send medical images utilizing DICOM standards. Storage capabilities can be provided within the system so that images may be reviewed and compared and downloaded electronically at a later point. Links to external video sources can be provided to allow for printing capabilities.

The subject apparatus can incorporate an external light source and various optical lenses with varying magnification features to accommodate for a variety of uses. Interface capabilities for connecting to a variety of digital cameras other than the unit can also be incorporated into the system.

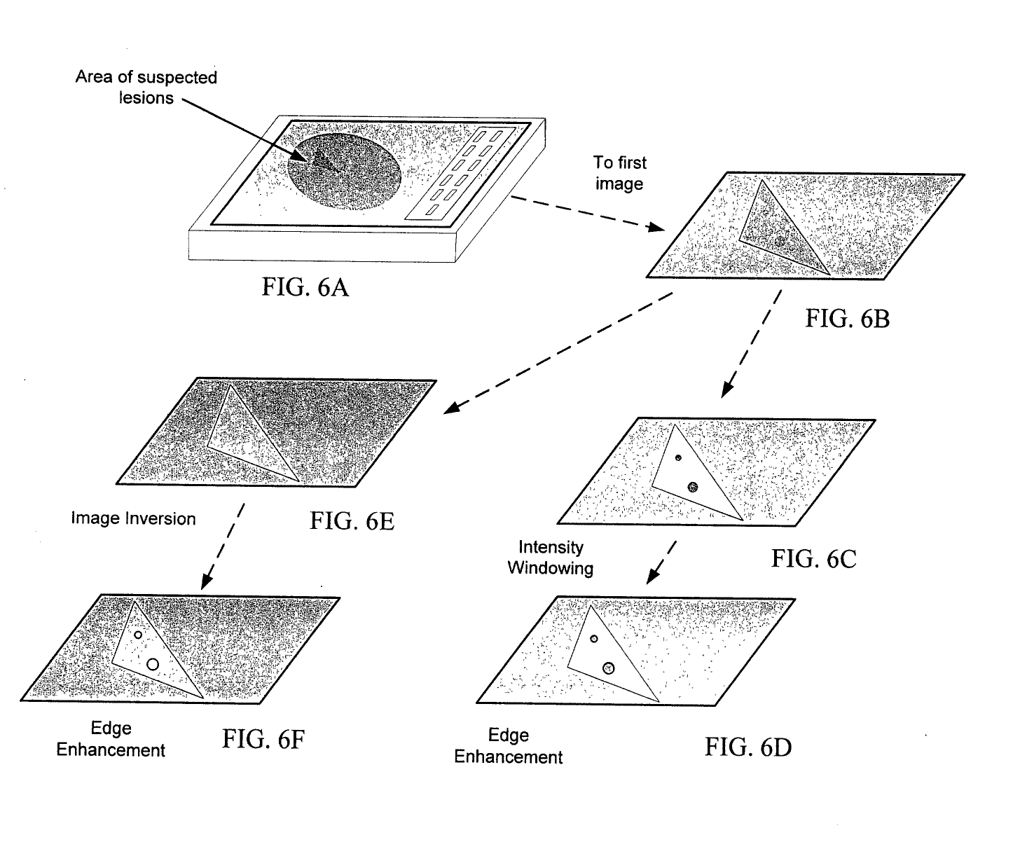

Referring to FIGS. 6A-6F, illustrations of some of the image enhancing processing which can be incorporated with the subject invention are shown. FIG. 6A shows the display screen of a specific embodiment of the subject invention while the device is being used to view a radiographic film, where the triangle region indicates an area of suspected lesions. FIG. 6B shows the display screen after high resolution magnification has been selected. The triangular area now shows a large circular area and a small circular area which may be of concern. FIG. 6C shows the display screen after the application of intensity windowing processing to the image shown in FIG. 6B. Intensity windowing is where the lightest pixels within the area of interest are rescaled to white, or the lightest possible of the display, and the darkest pixels within the area of interest are resealed to black, or the darkest possible of the display, with the other pixels rescaled proportionately between white and black based on their greyscale relative to the lightest and darkest pixel within the area of interest. Such intensity windowing can further enhance the ability of the user to differentiate the features within the area of interest from each other and from the background.

FIG. 6D shows the display after the application of edge enhancement processing to the image shown in FIG. 6C. Edge enhancement processing can draw edges where pixel intensity difference between adjacent pixels is above a certain threshold and, thus, can put edges around lesions or other features. Accordingly, edge enhancement can aid the user in locating and observing features of concern. Although FIG. 6D shows edge enhancement being applied after high resolution magnification and intensity windowing, such edge enhancement can be applied before magnification and/or before intensity windowing.

FIG. 6E shows the display after image inversion. Image inversion is essentially the process of switching white and black, such that the darkest pixels become the lightest and the lightest become the darkest. Of course, the pixels in the mid-range of intensity are also switched accordingly. There are some images where image inversion can make certain features stand out more. FIG. 6F shows the display of FIG. 6E after edge enhancement processing. Again, edge enhancement intensity windowing, and image inversion can each be applied alone or be applied in various combinations to see which permutation allows the user to best differentiate the features in the image.

An image of a mammographic film was taken with a smart cam having approximately 20 μm resolution of a group of the smallest microcalcifications in the American College of Radiology (ACR) accreditation phantom. A scanned and digitized image of the same film was then taken with a VIDAR film digitizer, with no image processing applied to either image. The microcalcifications appear easier to visually detect in the scanned image and digitized image than in the original image of the mammographic film. The comparison of the images demonstrate the superior resolution of the subject smart cam compared to the highest resolution commercially available film digitizer.

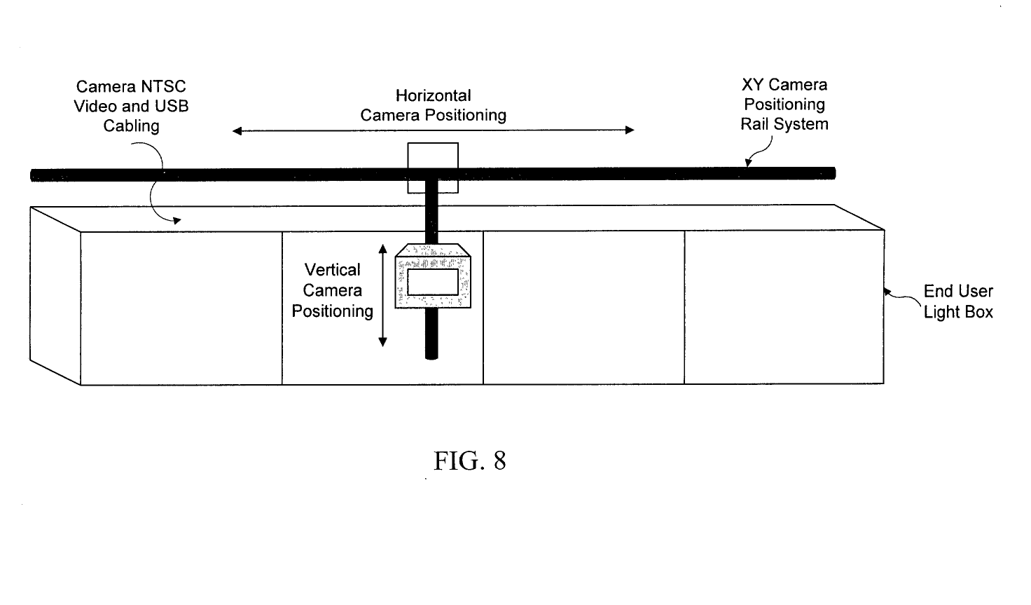

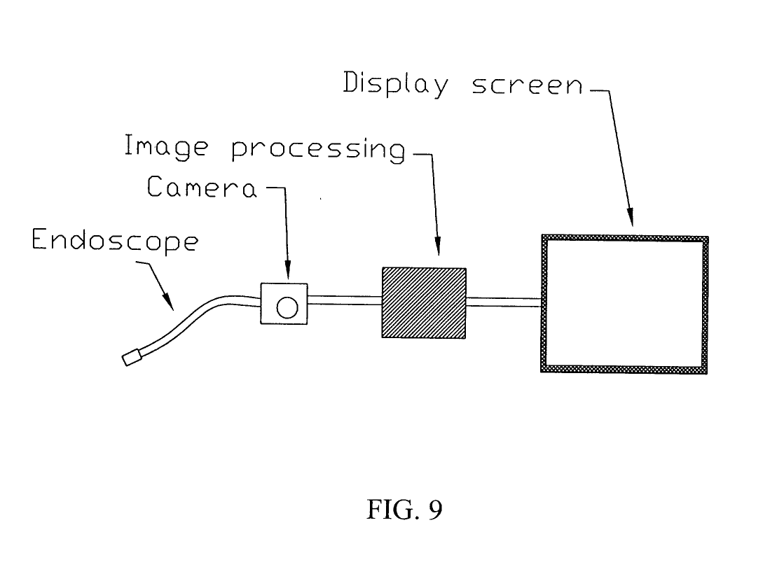

The subject apparatus may take a variety of forms including, without limitation, a magnifier with image processing utilizing LCD display with an electrical connection, a magnifier with image processing utilizing LCD display connected to a holding device, as illustrated in FIG. 8, a magnifier with image processing utilizing a pre-existing free standing display, an image processor with LCD display utilizing a camera that is not part of the device. Referring to FIG. 9, the subject camera, image processor, and display screen can be utilized with an endoscope. For an endoscope which already incorporates a camera, the subject image processor can be used to process the images from the camera in real-time and display the processed images either to the endoscope's standard display or to the subject display screen.

In a specific embodiment, the subject invention can be utilized for imaging mammographic films. These films can be situated on, for example, a standard light box. Since the film is on a light box, there is typically plenty of light available for the optical system and sensor chip. A standard C-mount for the lens can be used, which permits the use of different lenses. In a specific embodiment, the subject device can use an image display screen which has a 6.4 inch diagonal and a camera with 1280×1024 pixels. Hence, a 1:1, which we define as an “effective zoom,” lens imaging system would permit the same area of the film to be imaged. For a camera with 1280×1024 pixels and a 6.4 inch diagonal screen, the resolution of the display screen image is about 5 line pairs per mm. As the lens is zoomed to image a smaller area of the film, the resolution can be improved as seen in Table 2.

Table 2 shows the effect of the zoom lens on the area of film imaged
and the resolution of that image.

| | | Resolution of Image on LCD | |
|---|---|---|---|
| Effective Zoom | Area of Film Imaged | Screen | |
| 1:1 | 5.1″ × 3.8″ | ˜5 | lp/mm |
| 2:1 | 2.5″ × 1.9″ | ˜10 | lp/mm |
| 3:1 | 1.7″ × 1.3″ | ˜15 | lp/mm |
| 4:1 | 1.25″ × 0.95″ | ˜20 | lp/mm |

In a specific embodiment, a power zoom lens on a high quality consumer digital camcorder can be used for this application. For example, the automatic focus, 12× power zoom lens designed for the CANON OPTURA PI camcorder can be used. It has a minimum focusing distance of 1 cm on maximum wide angle. Due to the presence of display image artifacts produced by less than perfect CCDs, a preferred embodiment is to use scientific grade CCDs in the instrument to minimize artifacts.

The spatial resolution of typical mammographic film is about 25 microns. The digital sensor of the subject invention should have at least 1000×1000 pixels in order to image an area of about 1″×1 ″ on a typical mammographic film. CMOS solid-state image sensors such as MOTOROLA MCM20027IBMN 1.3 megapixel CMOS sensor can be used in this scenario. This chip is a 1280/1024 pixel camera chip with integrated digital programming, control, timing, and pixel correction.

Displays based on microdisplays (typically 1″×1″) such as KOPIN's line of high-resolution (1280×1024), low-cost, transmissive Active Matrix Liquid Crystal Display (AMLCD) can be used with the subject invention. Another example of a microdisplay which can be used is based on the organic light-emitting diode (OLED) technology. Microdisplays are often of such high resolution that they are only practically viewed with optics. For example, a magnified virtual image can be produced by a lens system contained in a headset worn by the radiographer. TOSHIBA produces a SVGA resolution LCD screen with 6.3″ diagonal. This is the highest pixel density LCD ever produced, which can be utilized with the subject invention.

For some radiographers, hand shake can be a mild problem when using a magnifying lens, especially at high magnification. Hand shake, or the shaking of the user's hand, can be exacerbated with a heavier device and having it attached to a swinging fixture can reduce the problem. Many designs of these fixtures exist and are available from, for example, EDMUND OPTICS, as well as other suppliers. The subject device can be designed to be used with or without such a fixture.

As discussed above, in a specific embodiment, the limiting spatial resolution of the subject device screen image can be comparable to the limiting resolution (20 lp/mm) of a mammographic film image.

The subject invention can be utilized in process quality control, where manufacturing or other processes can be monitored for quality assurance. The subject invention can provide real time enhancement and analysis of video images. In many of these processes, subtle indicators such as fungus, decay, or bacterial growth are often early indicators of problems in the process. In many cases, these indicators are difficult to detect by eye or in real time. The subject apparatus and method for enhancing images of an ongoing process in real time would provide more sensitive early detection of abnormalities, resulting in better control of the process and less waste.

The subject invention can also be utilized in Search and Rescue (S&R) missions, where one of the major problems encountered is the difficulty involved in viewing large expanses (on land or in the sea) in search of relatively small features, especially those features with relatively low contrast relative to the background. Scanning large areas by eye is the normal method of operation, yet missing persons or objects of interest can easily be missed with the naked eye. The subject method and apparatus can utilize a video camera (for example, sensitive in either visible or infrared bands) to image a search area, where the images can be enhanced in real time to emphasize small or indistinct objects such as a small raft, or a person on the ground by employing, for example, contrast enhancement and edge detection. Since S&R missions are carried out in real time, in a specific embodiment the processed image can be displayed to the operator in about 100 ms or less.

The subject invention can also be utilized in dentistry. Dental caries originate on the surface of the tooth, generally in small cracks or defects in the enamel coating. In the early stages, this decay can be arrested and reversed simply, often without need for drilling and filling of teeth. Unfortunately, in most cases the decay progresses inside of the tooth and is difficult to detect from the outside, requiring x-ray examinations to diagnose decay. Dental x-rays are typically a large source of potentially harmful radiation since they must be performed regularly to detect caries. The subject invention can utilize an imaging device used to generate real time video images of the teeth and then provide magnification, contrast enhancement, and/or edge detection in those images in real time to aid the dentist in detecting early stage caries. In order to be of practical use, this device must display the processed image to the user in about 100 ms or less to provide real-time viewing.

In a specific embodiment, the real time video images can be made using fluorescence from the teeth after excitation with short wavelength light. These images made from such fluorescence can provide better contrast for caries detection than reflected light. Image enhancement using fluorescent light can provide a superior sensitivity for the detection of early stage dental disease. Also in dentistry, tooth whiteness is an indicator of general dental health, as well as an important cosmetic consideration. The subject invention can provide a real time image enhancement device that applies sensitive color analysis algorithms and, in a specific embodiment, can present the processed image to the user in about 100 ms or less to provide rapid and accurate analyses of tooth whiteness. The use of color filters in the camera optics are also included within the scope of this invention.

The subject invention can also be utilized to detect and/or analyze early stage eye diseases, such as cataracts, glaucoma, and other diseases which are often indicated by small or otherwise subtle physical changes in the eye. For example, cataracts begin as a subtle cloudiness in the lens that can be very difficult to detect in the early stages. The subject invention can utilize a device for imaging the eye and a means for enhancing the images to emphasize indications of problems, such as cloudiness in the optical path, abnormalities on the retina, or other indications of disease could dramatically aid the detection of early stage eye disease.

One of the problems facing successful implementation of accurate biometric devices is the issue of contrast in the images. Many of the techniques for acquiring electronic images of fingerprints, retinas, faces, and other parts of the body for biometric purposes produce images that lack sufficient contrast information to perform a biometric examination. Further, one of the techniques used in biometrics is the application of infrared detectors, since many of the features of interest are more easily imaged in the infrared. However since these infrared techniques essentially produce images of body heat, they often have very little contrast information, since the differences in temperature across a feature of interest can be very small. The subject invention can provide a device employing thermal imaging techniques as well as powerful contrast enhancement, in order to improve the performance of biometric identification. In addition, the real-time nature of the invention makes it possible to continuously monitor the image in order to produce an optimal image for analysis and verification.In a specific embodiment of the subject invention, enhanced images can be alternately displayed with un-enhanced or differently enhanced images at video rates in order to utilize the averaging capabilities of human vision to produce the impression of a single image with characteristics from both sets of images. For example, the use of certain noise reduction techniques can be used to enhance the contrast sensitivity of certain objects in an image. These noise reduction techniques can also tend to reduce the resolution of the image. By alternating the noise-reduced image with the high spatial resolution (noisy) image at video rates (e.g. several frames per second or faster), a human viewer can experience the impression of a single image with both enhanced contrast (reduced noise) and high resolution. In a specific embodiment, the sets of images can be alternated at 15 fps or higher.

In a specific embodiment of the subject invention, the means for acquiring an image can be designed to be sensitive to electromagnetic radiation in bands other than visible light, for example ultraviolet, infrared, and/or microwave. Images produced in bands other than visible light can be used to observe features that may not be observable in visible light. The subject invention can process images in these other bands and prove useful in a wide variety of applications. As an example, passive millimeter wave imaging techniques are being employed for scanning airline passengers for weapons or contraband. An embodiment of the invention that employed a millimeter wave sensor could be implemented as a hand-scanning device at airports.

Following are examples which illustrate procedures for practicing the invention. These examples should not be construed as limiting.

### EXAMPLE 1

### Smart Camera for Mammography

An embodiment of the subject invention which can be utilized for interpreting and analyzing mammographic films is addressed in this example. The design and performance of such a device is driven by several user requirements, some of which are listed below.

1. The user requires sufficient visual access to the area around the region of interest. This can be achieved by, for example, physically separating the camera from the rest of the device. Such a design can reduce the occluded area of the suspected pathological area being viewed.

2. The image viewing screen is preferably unobstructed by the user□s hand when the user holds the device. This can be achieved by placing the handle behind the viewing screen and allowing adjustment of the angle of the viewing screen face relative to the line of sight of the user. Such adjustment of the angle can be achieved by, for example, allowing the viewing screen to swivel.

3. Users have different styles of holding the subject device. Preferably, the handle of the subject device can swivel and lock to accommodate different user physiologies and preferences. Control of window levels and image inversion can be conveniently located at the top of the handle and can be operated by the thumb.

4. It would be convenient for the subject device to be capable of being operated without attachment to an electrical outlet by an electrical cord. Accordingly, it is preferable for the subject device to be capable of operation on rechargeable batteries. Such batteries can be conveniently located in the handle. Recharging can be activated by placing the handle into a docking fixture, or cradle, when the device is not in use, such that electrical connections are made through the bottom of the handle and the batteries are recharged.

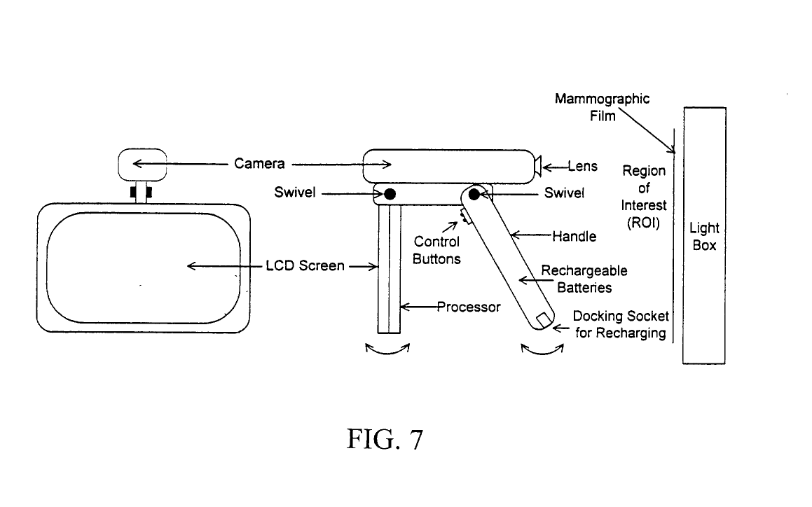

5. Space and weight considerations should be taken into account. The processor electronics which provide the functions of window leveling and image inversion can be housed at the back of the LCD as shown in FIG. 7. Alternatively, to minimize the weight of the hand-held embodiment, the processor and display unit can be separated from the hand-held imager but physically connected by wire.

### EXAMPLE 2

An embodiment of the subject invention employing a means of producing electronic images from ultraviolet light could be used in several applications:

Currency and high value documents are often produced with features visible only in the ultraviolet. The subject invention can be used to quickly identify these features.

Satellite imagery is often acquired in the ultraviolet for the purpose of identifying features not easily visible at other wavelengths. The invention described in this embodiment could be used to enhance and quickly identify features of interest in these images, and the ability to process several frames per second allows for real time use in this embodiment.

### EXAMPLE 3

An embodiment of the subject invention employing a means of producing electronic images from infrared light could be used in several applications:

In the area of biometric identification, infrared light can be used as a means of more accurately imaging features of interest such as fingerprints, retinas, the iris, or the face. Because in these applications, illumination is not used and the IR energy is derived from the body's internal heat generating mechanisms, infrared provides a means of seeing deeper under the surface where heat is produced and imaging the subsurface features through which that energy must pass before emitting from the surface of the skin. By using powerful contrast enhancement to emphasize subtle differences in temperature, the subject invention can be used to enhance such images associated with the sub-surface physical structure, resulting in more accurate and unique biometric identification. This subsurface information may be coupled with visual images as well.

Since infrared can be used to image subdermal features within the human body, the subject invention can be used to search for evidence of prior cosmetic surgery or injuries before surgery or other medical procedures. This information can be useful to a surgeon in the planning of further surgical procedures.

Satellite imagery is often acquired in the infrared for the purpose of identifying features not easily visible at other wavelengths and for producing thermal maps of the surface. The subject invention can be used to enhance and quickly identify features of interest in such images by, for example, using constrast enhancement to emphasize small differences in temperature and edge enhancement to emphasize the outline of objcts of interest.

Missiles often use infrared detectors as an input to their guidance systems. Active systems such as aircraft or tanks at which the missiles are aimed tend to produce thermal energy. The subject invention can be used to enhance these often low contrast images to identify and more accurately characterize thermal sources in images of targets, and improve the accuracy of targeting and guidance systems. While optical processors can be used for real-time targeting in missiles, the subject invention can provide a low cost means of image enhancement for the images generated by existing optical processor output.

In search and rescue missions, infrared imagers are useful in identifying warm objects against a cooler background such as a person against the sea. However, these systems need to image large search areas and a target of interest can be very small against the background and hard to detect. Also, the temperature difference between the body and seawater in warm climates is not very great, again making detection difficult. The subject invention can be used to provide contrast enhancement and magnification of target objects in thermal images, rendering them easier to detect in real time. The inverse situation is also encountered where a low contrast warm body is to be detected in a cold body of water. The subject invention can be used in that case as well.

Heat flow can be a useful tool in the inspection of thermally conductive parts, such as aircraft turbines. Interruptions or discontinuities in heat flow can indicate cracks or other flaws in the structure. These heat flow patterns can be observed at the surface in the infrared. The subject invention can be used to enhance contrast in these images, causing subtle differences in temperature to be magnified and thus easier to detect and identify.

Stealth systems go through great pains to reduce the thermal signature of their heat-producing engines in order to avoid detection by thermal imaging. However, since these systems (aircraft or tanks for example) do produce heat, it is virtually impossible to completely eliminate a thermal signature. The subject invention can be used to enhance this reduced signature by improving contrast and providing magnification of the image, and thereby improve the detection capabilities of anti-stealth systems. Rapid refresh rates are important since these systems move rapidly.

### EXAMPLE 4

An embodiment of the subject invention employing a means of producing electronic images from microwave radiation (such as radar) could be used in several applications:

Stealth systems are specifically designed to reduce their radar profile in order to avoid detection by. However, it is virtually impossible to completely eliminate a radar return from these vehicles, although the profile may be reduced considerably. The subject invention can be used to enhance this reduced profile, and thereby improve the detection and characterization capabilities of anti-stealth systems.

It should be understood that the examples and embodiments described herein are for illustrative purposes only and that various modifications or changes in light thereof will be suggested to persons skilled in the art and are to be included within the spirit and purview of this application and the scope of the appended claims.

### REFERENCES

Mammography and Beyond: Developing Technologies for the Early Detection of Breast Cancer, Institute of Medicine, p. 184, 2001.

Innovations, Inc., Littleton, Colo., make a portable, electronic magnifier for people with poor vision.

1. A device for viewing one or more objects, comprising:
a means for acquiring an image of one or more objects every t seconds, wherein t is less than about 1 second,
a means for processing each acquired image, and
a means for displaying each processed image to a user, wherein processing the acquired image enhances the user's ability to identify features of interest of the one or more objects from the processed image.

2. The device according to claim 1, wherein said one or more objects is a radiographic x-ray film

3. The device according to claim 1, wherein t is less than about 500 milliseconds.

4. The device according to claim 1, wherein t is less than about 100 milliseconds.

5. The device according to claim 1, wherein t is less than about 34 milliseconds.

6. The device according to claim 1, wherein the means for processing each acquired image implements one or more processing techniques selected from the group consisting of: magnification, window leveling, edge enhancement, image inversion, image intensity enhancement, automatic focus control, automatic exposure control, automatic magnification (zoom) control, and steady cam.

7. The device according to claim 6, wherein the means for processing each acquired image comprises a means for allowing the user to select which processing technique(s) are implemented.

8. The device according to claim 1, further comprising:
a means for examining one or more processed images and identifying features of interest of the one or more objects from the one or more processed images.

9. The device according to claim 8, wherein the means for examining one or more processed images and identifying features of interest of the one or more objects from the one or more processed images provides an identifier of the features of interest on the processed image displayed to the user.

10. The device according to claim 2, wherein the spatial resolution of each processed image is at least about 5 line pairs per millimeter at the object plane.

11. The device according to claim 2, wherein the spatial resolution of each processed image is at least about 10 line pairs per millimeter at the object plane.

12. The device according to claim 1, wherein the means for acquiring an image comprises a camera.

13. The device according to claim 1, wherein the means for displaying each processed image to a user comprises a display selected from the group consisting of: a LCD screen, an organic light emitting display (OLED), a heads-up display, and a cathode ray tube (CRT).

14. The device according to claim 1, wherein the means for displaying each processed image to a user comprises a heads-up display.

15. The device according to claim 2, further comprising:
a means for holding the means for acquiring an image, wherein the means for holding the means for acquiring an image is fixedly positioned relative to a light box for displaying the radiographic x-ray film such that the means for holding the means for acquiring an image is changeably positionable such that the field of view of the device can be positioned to acquire an image from a desired portion of a radiographic x-ray film displayed on the light box.

16. The device according to claim 15, wherein the means for holding the means for acquiring an image allows continuous movement of the means for acquiring an image with respect to the radiographic x-ray film such that the means for acquiring an image can scan the radiographic x-ray film.

17. The device according to claim 1, further comprising a means to freeze a processed image on the means for displaying the processed image to a user.

18. The device according to claim 1, wherein each processed image is displayed to the user within about t seconds after being acquired

19. A method of viewing one or more objects, comprising:
acquiring an image of one or more objects every t seconds, wherein t is less than about 1 second
processing each acquired image, and
displaying each processed image to a user, wherein each processed image is displayed to the user within about t second after being acquired, wherein processing each acquired image enhances the user's ability to identify features of interest of the one or more objects from the processed image.

20. The method according to claim 19, wherein the one or more objects is a radiographic x-ray film.

21. The method according to claim 19, wherein t is less than about 500 milliseconds.

22. The method according to claim 19, wherein t is less than about 100 milliseconds.

23. The method according to claim 19, wherein t is less than about 34 milliseconds.

24. The method according to claim 19, wherein processing each acquired image implements one or more processing techniques selected from the group consisting of: magnification, window leveling, edge enhancement, image inversion, image intensity enhancement, automatic focus control, automatic exposure control, automatic magnification (zoom) control, and steady cam.

25. The method according to claim 24, wherein the means for processing each acquired image allowing the user to select which one or more processing technique(s) are implemented.

26. The method according to claim 20, wherein the spatial resolution of each processed image is at least five and preferably ten or more line pairs per millimeter at the object plane.

27. The method according to claim 20, wherein the spatial resolution of each processed image is at least 10 line pairs per millimeter at the object plane.

28. The method according to claim 18, wherein acquiring an image comprises acquiring an image with a camera.

29. The method according to claim 28, wherein displaying each processed image to a user comprises displaying each processed image to a user on a display selected from the group consisting of: a LCD screen, an organic light emitting display (OLED), a heads-up display, and a cathode ray tube (CRT).

30. The method according to claim 28, further comprising:
allowing movement of the camera with respect to the radiographic x-ray film such that images can be acquired from a plurality of desired portions of the radiographic x-ray film.

31. The method according to claim 19, wherein the radiographic x-ray film is selected from the group consisting of: mammographic, general chest, and bone fracture.

32. The method according to claim 19, wherein the radiographic x-ray film is mammographic.

33. The device according to claim 1, wherein the device is adapted to be handheld by the user.

34. A device for identifying features of interest on one or more objects, comprising:
a means for acquiring an image of one or more objects every t seconds, wherein t is less than about 1 second,
a means for processing each acquired image, and
a means for examining one or more processed images and identifying features of interest of the one or more objects in the one or more processed images.

35. The device according to claim 34, wherein the one or more objects is a radiographic x-ray film.

36. The device according to claim 34, wherein t is less than about 100 milliseconds.

37. The device according to claim 34, further comprising:
a means for displaying the processed images to a user.

38. The device according to claim 37, wherein each processed image is displayed to the user within about t seconds after being processed.

39. The device according 37, further comprising:
a means for providing an identifier of the features of interest on the processed images displayed to the user.

40. A device for viewing one or more objects, comprising:
a means for acquiring an image of one or more objects every t seconds, wherein the t is less than about 1 second,
means for processing at least a portion of the acquired images to produce processed images with reduced noise,
means for alternately displaying the processed images with reduced noise and the acquired images to a user, wherein such alternating display provides the user an impression of a single image with both the resolution of the acquired images and the contrast of the processed images with reduced noise.

41. The device according to claim 40, wherein the one or more objects is a radiographic x-ray film.

42. A device for identifying features of interest on one or more objects, comprising:
a means for acquiring an image of one or more objects every t seconds, wherein t is less than about 1 second,
a means for processing at least a portion of the acquired images to produce processed images with reduced noise,
a means for examining the acquired images and the processed images with reduced noise and identifying features of interest on the one or more objects, wherein examining the acquired images and the processed images with reduced noise enhances identification of features of interest on the one or more objects by utilizing the resolution of the acquired image and the contrast of the processed images with reduced noise.

43. The device according to claim 42, wherein the one or more objects is a radiographic x-ray film.

44. The device according to claim 42, further comprising:
a means for displaying at least a portion of the processed images to a user, and
a means for providing an identifier of the features of interest on the processed images displayed to the user.

45. The device according to claim 42, further comprising:
a means for displaying at least a portion of the acquired images to a user, and
a means for providing an identifier of the features of interest on the acquired image displayed to the user.

46. The device according to claim 45, further comprising:
a means for alternatively displaying the processed images with reduced noise and the acquired images to a user, wherein such alternating display provides the user an impression of a single image with both the resolution of the acquired images and the contrast of the processed images with reduced noise.

47. A device for enhancing real-time video images, comprising:
a means for receiving images from an external imaging system at a rate of at least one image per about 1 second,
a means for processing each acquired image, and
a means for sending the processed images to an external display system, wherein processing the received images enhances the user's ability to interpret the image.

48. The device according to claim 47, further comprising:
a means for examining a least a portion of the processed images and identifying features of interest.

49. The device according to claim 47, wherein the external imaging system is an endoscopic imaging system.

50. A device for enhancing real-time video images, comprising:
a means for receiving images from an external imaging system at a rate of at least one image per about 1 second,
a means for processing each acquired image, and
a means for examining the processed images for the purpose of identifying feature of interest in the processed images, and
a means for sending the processed images to an external display system.
